(19) United States
(12) Patent Application Publication
(10) Pub. No.: US 2013/0307990 A1
(43) Pub. Date: Nov. 21, 2013

(54) SYSTEM AND METHOD FOR REAL-TIME VIDEO PROCESSING FOR ALARM MONITORING SYSTEMS

(71) Applicant: TRANSPORTATION SECURITY ENTERPRISES, INC. (TSE), El Dorado Hills, CA (US)

(72) Inventors: Brian C. Wiles, Cameron Park, CA (US); Douglas M. Stone, Placerville, CA (US)

(73) Assignee: TRANSPORTATION SECURITY ENTERPRISES, INC. (TSE), El Dorado Hills, CA (US)

(21) Appl. No.: 13/680,074

(22) Filed: Nov. 18, 2012

Related U.S. Application Data
(60) Provisional application No. 61/649,346, filed on May 20, 2012.

(51) Int. Cl. G08B 25/00

(52) U.S. Cl. CPC G08B 25/00
USPC 348/159; 348/143

(57) ABSTRACT

A system and method for real-time video processing for alarm monitoring systems are disclosed. A particular embodiment includes: receiving alert data from a video image analysis module, the alert data being generated from analysis of a video feed, the alert data being in a first format; translating the alert data to a second format; and causing the alert data in the second format to be communicated to an alarm monitoring system compatible with the second format.

### PRIORITY PATENT APPLICATION

This non-provisional U.S. patent application claims priority to U.S. provisional patent application Ser. No. 61/649,346; filed on May 20, 2012 by the same applicant as the present patent application. This present patent application draws priority from the referenced patent application. The entire disclosure of the referenced patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2010-2012, Transportation Security Enterprises, Inc. (TSE); All Rights Reserved.

### TECHNICAL FIELD

This patent application relates to a system and method for use with video capture systems, real time data collection systems, alarm monitoring systems, and sensor systems, according to one embodiment, and more specifically, to a system and method for real-time video processing for alarm monitoring systems.

### BACKGROUND

The use of analog or digital video cameras for video surveillance with security systems is well known. For example, U.S. Pat. No. 7,643,056 describes a motion detecting camera system that includes a portable motion detection device having an image sensor for detecting motion within a field of view of the motion detection device and automatically generating a digital image of a scene within the field of view upon detection of motion. U.S. Pat. No. 6,803,945 describes a camera system that includes a video camera and a processor, which periodically uploads images captured by the video camera to a web server in accordance with one of a plurality of motion detection algorithms. A first motion detection algorithm captures a current image frame when a pixel comparison between successive image frames exceeds a predetermined threshold. In some cases, images from analog, video cameras can be digitized for image processing. Internet Protocol (IP) video cameras can capture images and upload the images to a configurable IP address. U.S. Pat. No. 6,323,897 describes a monitor camera unit that includes a motion detector that detects motion from video data and a memory for storing the video data. The memory stores the video data in response to the motion detector. A control server receives alarm data from the monitor camera and further receives the alarm type data, time data, position data of a pivoting unit for pivoting the camera unit and transmits the data to a display terminal.

However, conventional video processing systems for video surveillance, such as the one described in U.S. Pat. No. 6,323,897, are typically closed systems that use proprietary data formats and alarm protocols. As such, these conventional video processing systems are not compatible with other alarm monitoring systems that may use different interfaces, data formats, and/or alarm protocols.

### BRIEF DESCRIPTION OF THE DRAWINGS

The various embodiments is illustrated by way of example, and not by way of limitation, in the figures of the accompanying drawings in which:

FIG. 1 illustrates an example embodiment of a system and method for real-time video processing for alarm monitoring systems;

FIG. 2 illustrates another example embodiment of a system and method for real-time video processing for alarm monitoring systems;

FIG. 3 illustrates yet another example embodiment of a system and method for real-time video processing for alarm monitoring systems;

FIG. 4 illustrates yet another example embodiment of a system and method for real-time video processing for alarm monitoring systems;

FIG. 5 illustrates yet another example embodiment of a system and method for real-time video processing for alarm monitoring systems;

FIG. 6 is a processing flow chart illustrating an example embodiment of a system and method for real-time video processing for alarm monitoring systems as described herein; and

FIG. 7 shows a diagrammatic representation of machine in the example form of a computer system within which a set of instructions when executed may cause the machine to perform any one or more of the methodologies disclosed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

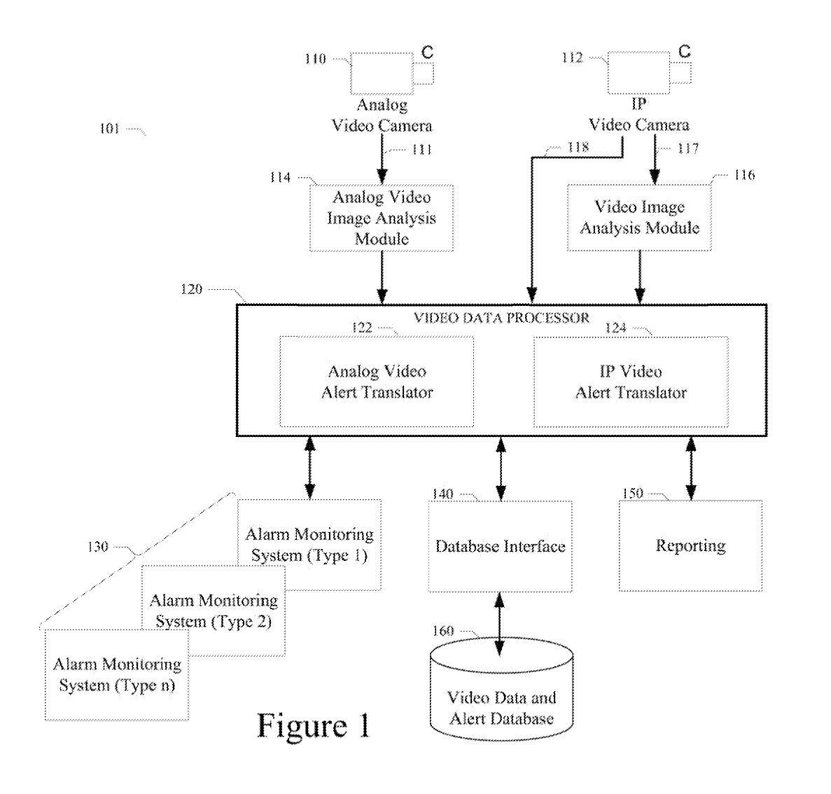

Referring to FIG. 1, in an example embodiment, a system and method for real-time video processing for alarm monitoring systems are disclosed. Many conventional alarm systems include an array of video cameras or other video capture devices positioned in a monitored venue at various locations. These conventional video cameras can include analog video and/or digital video cameras. Digital video cameras can be IP video cameras, which can capture images and upload the images to is configurable IP address. FIG. 1 shows an example of a conventional analog video camera 110 and a conventional IP video camera 112. Conventional analog video camera 110 generates a real-time stream of analog video data 111 representing video images captured by the video camera 110. Conventional IP video camera 112 generates a real-time stream of digital video data 117 and 118 representing video images captured by the IP video camera 112. These real-time video streams or feeds represent video images of locations in the monitored venue over time. In some cases, these video images can be static if there is no activity or moving objects in the camera's field of view. Static images are the same (or very similar) images at different points of time.

The real-time stream of analog video data 111 and/or the real-time stream of digital video data 117 can be provided as an input to analog video analysis module 114 and/or video image analysis module 116, respectively. The analog video analysis module 114 and/or the video image analysis module 116 can receive a real-time video feed and perform image analysis on the video images in the video feed. In some cases, video feeds from analog video cameras can be digitized for image analysis by a video analysis module. The image analysis can include motion detection. The motion detection can include comparing a current captured image frame with successive captured image flames to determine if the differences in the image frames exceed a predetermined threshold. If a predetermined threshold of difference exists, the analog video analysis module 114 and/or the video image analysis module 116 can signal that motion has been detected in the monitored venue or that some anomaly has occurred in the camera's field of view. These signals can be in the form of various types of alerts or alarms that can be processed by other security systems, such as the alarm monitoring systems described in more detail below.

Conventional systems provide various levels and types of video image analysis capabilities, which can be performed by the analog video analysis module 114 and/or the video image analysis module 116. Unfortunately, conventional video image analysis systems provide alert or alarm output in a variety of different and often incompatible forms. In some cases, the alert or alarm output produced by the analog video analysis module 114 and/or the video image analysis module 116 can include merely an indication that motion was detected in the video feed. In other cases, the alert or alarm output produced by the analog video analysis module 114 and/or the video image analysis module 116 can include an indication that motion was detected in the video feed, an alarm type, time data, position data of a pivoting unit for pivoting the camera unit, and the like. Some conventional video image analysis modules can also provide X, Y, and possibly Z coordinates of the motion detected within a video frame(s). The Z coordinate can be based upon height, angle, and distance from known points calibrated within the video image analysis module. The alert or alarm output produced by the analog video analysis module 114 and/or the video image analysis module 116 can be provided in a variety of formats, interfaces, protocols, and the like. As a result, it is often difficult to reconcile the alert or alarm output produced by different types of video image analysis modules 114 or 116. A further complicating factor is that certain types of analog video cameras 110 or IP video cameras 112 can only operate with particular types of analog video analysis modules 114 or video image analysis modules 116, respectively. Thus, it becomes very difficult to design video surveillance systems that might use different cameras in different locations in a monitored venue.

An additional factor complicating the design of conventional video surveillance systems is the presence of a variety of different types of alarm monitoring systems 130 as shown in FIGS. 1 through 3. Each of the alarm monitoring systems 130 represent a particular type of conventional alarm monitoring system. For example, an alarm monitoring system called Merlin™ produced by Initsys™ provides control room software that incorporates traditional alarm monitoring linked to access control, CCTV and crisis, event and video wall management. The various types of alarm monitoring systems 130 can only process the alert or alarm data produced by a compatible video image analysis module, which can only process a video feed from a compatible video camera. In most cases, conventional alarm monitoring systems 130 have a very limited capability for handling alert or alarm data from different types of video image analysis modules or different types of video cameras.

Referring still to FIG. 1, an example embodiment provides a video data processor 120 interposed between a plurality of video image analysis modules 114/116 and one or more alarm monitoring systems 130. The video data processor 120 is configured to receive one or more video feeds 118 and/or a plurality of alert/alarm output data from a plurality of video image analysis modules 114/116. The video data processor 120 is also configured to be in data communication with a database interface 140, a database 160 via the database interface 140, and a reporting module 150. The system 101 as shown in the example embodiments of FIG. 1 can be used as a security system for one or more monitored venues.

As shown in FIG. 1, the video data processor 120 can receive alert/alarm data from a plurality of video image analysis modules 114/116. As described above, the alert/alarm data can be in a variety of formats, interfaces, protocols, and the like. The video data processor 120 is configured to translate the alert/alarm data from a particular format, interface, or protocol provided by a particular type of video analysis image analysis module into a common alert/alarm format. An analog video alert translator 122 is provided by video data processor 120 to translate the alert/alarm data from particular types of analog video image analysis modules 114 into the common alert/alarm format. The analog video alert translator 122 may also include a sensor to detect the presence or lack of electrical current on a circuit when the analog video camera 110 has detected motion in a scene. Thus, the analog video translator 122 may be a physical device controlled by a microcontroller or other hardware device. An IP video alert translator 124 is provided by video data processor 120 to translate the alert/alarm data from particular types of video image analysis modules 116 into the common alert/alarm format. In a particular embodiment, the video data processor 120 can also receive a raw video feed 118, perform video image analysis on the video feed, and produce corresponding alert/alarm data in the common alert/alarm format. As a result, the video data processor 120 can support a variety of different types of video image analysis modules 114/116 and a variety of different types of video cameras 110/112. In each case, the video data processor 120 can produce a plurality of alert/alarm data sets from a plurality of video feeds, wherein the plurality of alert/alarm data sets are all in a common alert/alarm format. The alert/alarm data sets can also be augmented with meta data to identify the source of the video feed, to identify the source video image analysis module, to identify the source video camera, the time, date, and location of the alert/alarm data set. The video feed data, the alert/alarm data sets with meta data, and the processing status of the video data processor 120 can be captured and retained in the database 160 via the database interface 140.

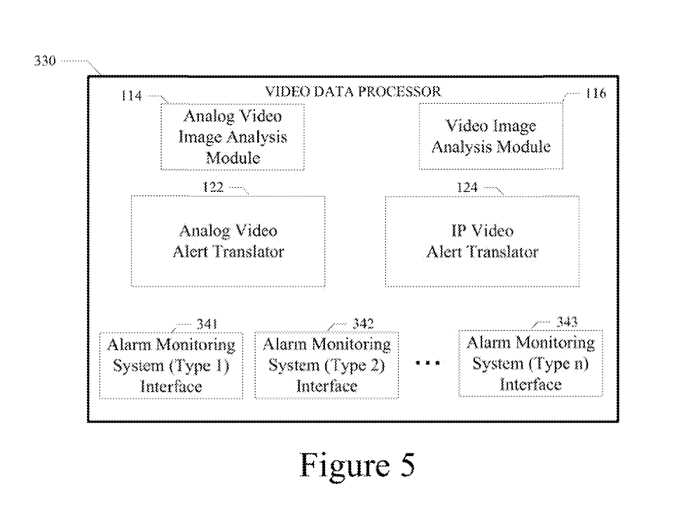

Referring again to FIG. 1, the video data processor 120 is in data communication with one or more alarm monitoring systems 130. As described above, each alarm monitoring system 130 can be of a different type, each using a different format, interlace, or protocol for receiving the alert or alarm data produced by a compatible video image analysis module. The video data processor 120 can be configured to produce alert or alarm data that is compatible with a particular type of alarm monitoring system 130. For example, the video data processor 120 can be configured for connection to an alarm monitoring system 130 of type 1. For example, the alarm monitoring system 130 of type 1 can be a conventional alarm monitoring system called Merlin™ produced by Initsys.™ As part of the configuration of the video data processor 120 for a type 1 alarm monitoring system 130, the video data processor 120 can retrieve alert/alarm data sets from the database 160. As described above, the alert/alarm data sets can be stored in a common alert/alarm format. The video data processor 120 can convert the retrieved alert/alarm data sets from the common alert/alarm format to a format compatible with the type 1 alarm monitoring system 130, for example. As shown in FIG. 5, the video data processor 330 can include a plurality of alarm monitoring system interfaces 341-343, each alarm monitoring system interface corresponding to a particular type of alarm monitoring system 130. The video data processor 330 can use a corresponding alarm monitoring system interface 341, for example, to communicate the converted alert/alarm data set to the type 1 alarm monitoring system 130, for example. Similarly, the video data processor 120 can be configured to provide compatible alert/alarm data sets to any of a plurality of corresponding alarm monitoring systems of different types. The video data processor 120 can collect processing data, alert/alarm status data, configuration data, and the like and produce data reports using the reporting module 150. System users can view these data reports to assess the operation and status of the video data processing system. Thus, the video data processor 120 can support a variety of different types of video image analysis modules 114/116 with a variety of different types of video cameras 110/112 and enable communication between these different analysis modules/video cameras and any type of alarm monitoring system 130, even if the alarm monitoring system 130 is not compatible with the analysis module/video camera. The embodiments described herein thereby enable the use of a variety of different kinds of video surveillance equipment in a unified system.

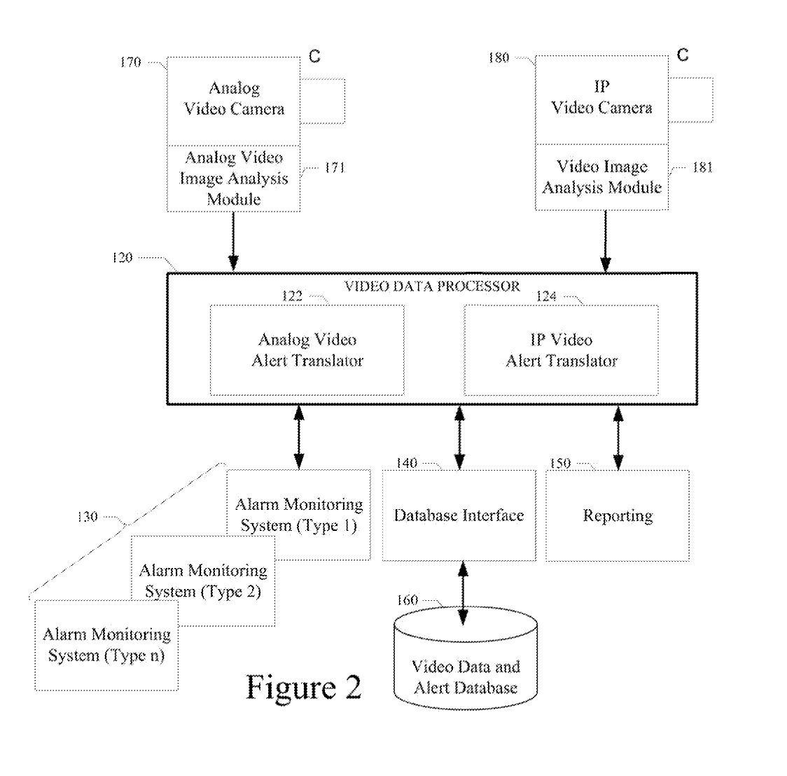

FIG. 2 illustrates another example embodiment of a system and method for real-time video processing for alarm monitoring systems. In the example of FIG. 2, the analog video image analysis module 171 can be integrated into the analog video camera 170. Similarly, the video image analysis module 181 can be integrated into the IP video camera 180. In some cases, video cameras have a built-in video image analysis capability that can perform motion detection or other forms of alert/alarm generation. These kinds of cameras can be used with the video data processor 120 as described above and shown in FIG. 2.

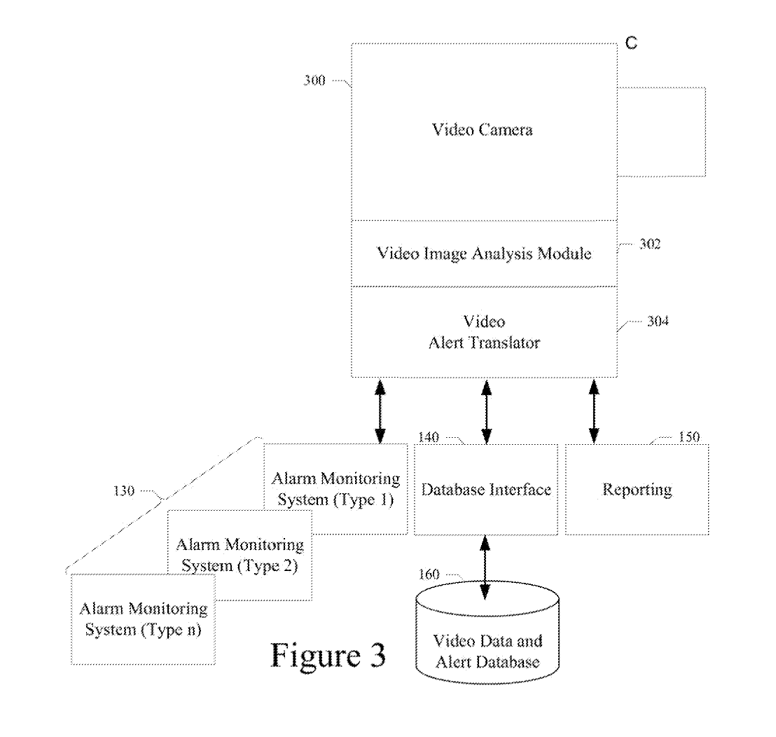

FIG. 3 illustrates yet another example embodiment of a system and method for real-time video processing for alarm monitoring systems. In the example of FIG. 3, the video image analysis module 302 and the video alert translator 304 can be integrated into the video camera 300. The video alert translator 304 can perform the same or similar functions as the IP video alert translator 124 as described above. The embodiment shown in FIG. 3 enables an alarm monitoring system 130 interface to be connected directly to a video camera 300, which has the integrated analysis module 302 and the video alert translator 304. The video alert translator 304 can be installable and/or downloadable to the camera 300, so the camera 300 can be made compatible with a variety of alarm monitoring systems 130.

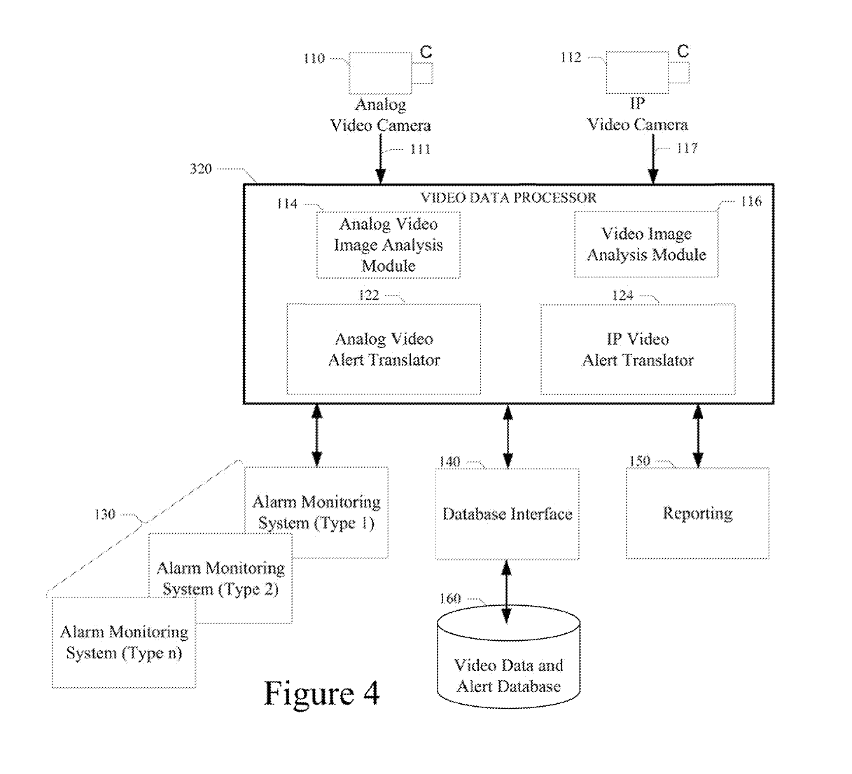

FIG. 4 illustrates yet another example embodiment of a system and method for real-time video processing for alarm monitoring systems. In the example of FIG. 4, the analog video image analysis module 114 can be integrated into the video data processor 320. Similarly, the video image analysis module 116 can be integrated into the video data processor 320. In some cases, video cameras may not have a built-in video image analysis capability that can perform motion detection or other forms of alert/alarm generation. In these cases, the video data processor 320 can be configured to support these kinds of video cameras. These video cameras can be used with the video data processor 320 as described above and shown in FIG. 4.

FIG. 5 illustrates yet another example embodiment of a system and method for real-time video processing for alarm monitoring systems. In the example of FIG. 5, the video data processor 330 can include a plurality of alarm monitoring system interfaces 341-343, each alarm monitoring system interface corresponding to a particular type of alarm monitoring system 130. The video data processor 330 can use a corresponding alarm monitoring system interface 341, for example, to communicate the converted alert/alarm data set to the type 1 alarm monitoring system 130, for example. In this manner, the video data processor 330 can be configured to support a plurality of different types of alarm monitoring systems 130.

The video data processor 120/320/330 can be implemented as one or more software modules or components, which are executable by a data processor. Similarly, the analog video alert translator 122 and the IP video alert translator 124 can be implemented as one or more software modules or components, which are executable by a data processor. Again, the analog video alert translator 122 may also include a sensor to detect the presence or lack of electrical current on a circuit when the analog video camera 110 has detected motion in a scene. Thus, the analog video translator 122 may be a physical device controlled by a microcontroller or other hardware device. The video alert translator 304 can also be implemented as one or more software modules or components, which are executable by a data processor. The plurality of alarm monitoring system interfaces 341-343 can also be implemented as one or more software modules or components, which are executable by a data processor.

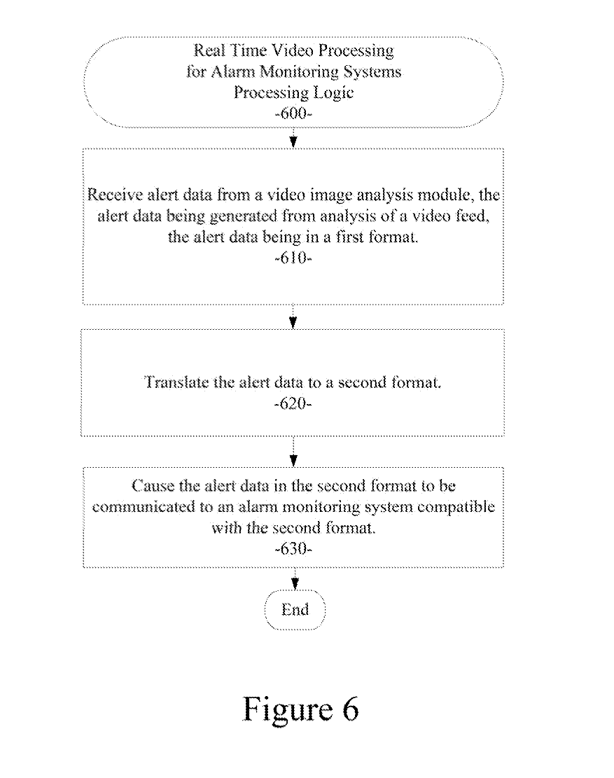

FIG. 6 is a processing flow diagram illustrating an example embodiment of a system and method for real-time video processing for alarm monitoring systems as described herein. The method 600 of an example embodiment includes: receiving alert data from a video image analysis module, the alert data being generated from analysis of a video feed, the alert data being in a first format (processing block 610); translating the alert data to a second format (processing block 620); and causing the alert data in the second format to be communicated to an alarm monitoring system compatible with the second format (processing block 630).

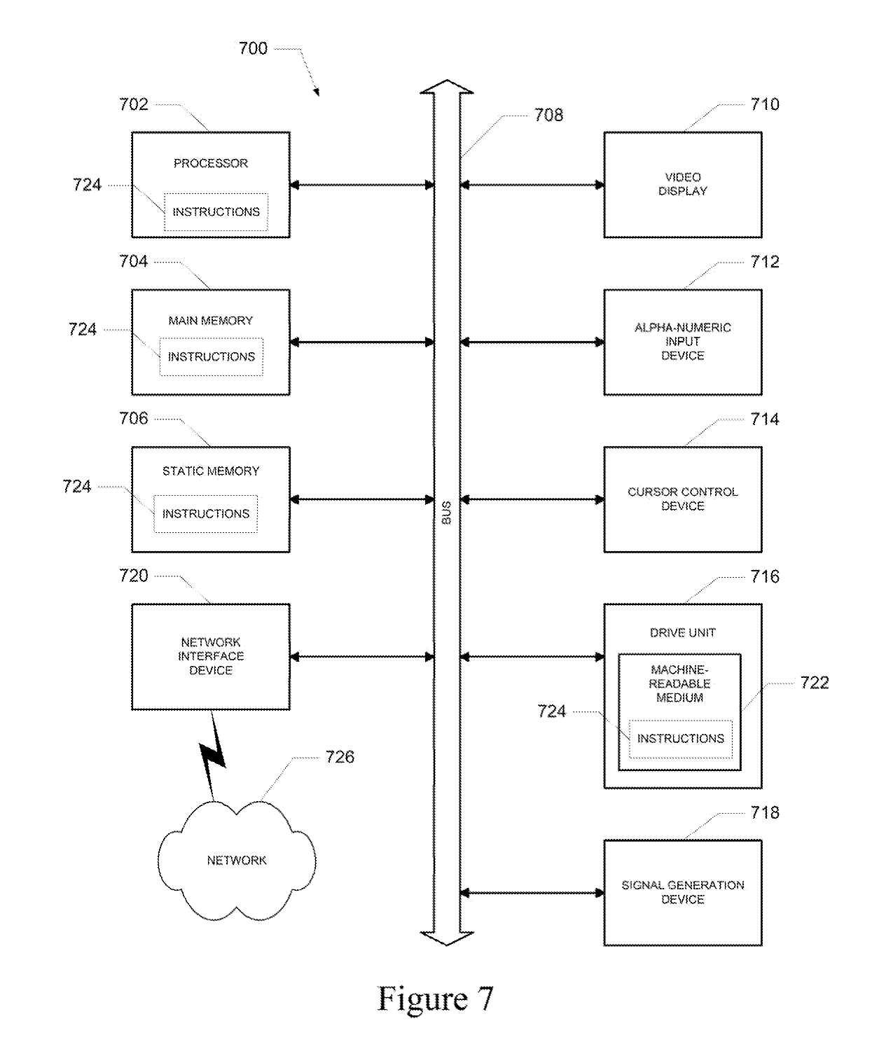

FIG. 7 shows a diagrammatic representation of a machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, a video camera, image or audio capture device, sensor device, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a data processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a non-transitory machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single non-transitory medium or multiple media (e.g., as centralized or distributed database, and/or associated caches and servers) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

We claim:

1. A method comprising:
receiving alert data from a video image analysis module, the alert data being generated from analysis of a video feed, the alert data being in a first format;
translating, by use of a data processor, the alert data to a second format; and
causing the alert data in the second format to be communicated to an alarm monitoring system compatible with the second format.

2. The method as claimed in claim 1 wherein the video feed is sourced from an analog video camera.

3. The method as claimed in claim 1 wherein the video feed is sourced from a digital video camera.

4. The method as claimed in claim 1 wherein the analysis of the video feed includes performing motion detection.

5. The method as claimed in claim 1 including translating the alert data to a common format and translating the alert data in the common format to the second format.

6. The method as claimed in claim 1 including storing the alert data in a database.

7. The method as claimed in claim 1 including configuring a video data processor to translate alert data from one of as plurality of formats compatible with one of a plurality of different video image analysis modules.

8. The method as claimed in claim 1 including configuring to video data processor to translate alert data to one of a plurality of formats compatible with one of a plurality of different alarm monitoring systems.

9. The method as claimed in claim 1 including integrating a video data processor into a video camera.

10. A system comprising:
a plurality of video cameras;
a plurality of video image analysis modules each coupled to one of the plurality of video cameras; and
a video data processor configured to:
receive alert data from the plurality of video image analysis modules, the alert data being generated from analysis of a video feed from one of the plurality of video cameras, the alert data being in a first format;
translating the alert data to a second format; and
causing the alert data in the second format to be communicated to an alarm monitoring system compatible with the second format.

11. The system as claimed in claim 10 wherein the video feed is sourced from an analog video camera.

12. The system as claimed in claim 10 wherein the video feed is sourced from a digital video camera.

13. The system as claimed in claim 10 wherein the analysis of the video feed includes performing motion detection.

14. The system as claimed in claim 10 including translating the alert data to a common format and translating the alert data in the common format to the second format.

15. The system as claimed in claim 10 including storing the alert data in a database.

16. The system as claimed in claim 10 including configuring the video data processor to translate alert data from one of a plurality of formats compatible with one of a plurality of different video image analysis modules.

17. The system as claimed in claim 10 including configuring the video data processor to translate alert data to one of a plurality of formats compatible with one of a plurality of different alarm monitoring systems.

18. The system as claimed in claim 10 including integrating the video data processor into a video camera.

19. A video camera comprising:
a video image capturing module;
a video image analysis module coupled to the video image capturing module; and
a video data processor configured to:
receive alert data from the video image analysis module, the alert data being generated from analysis of as video feed from the video image capturing module, the alert data being in a first format;
translating the alert data to a second format; and
causing the alert data in the second format to be communicated to an alarm monitoring system compatible with the second format.

20. The video camera as claimed in claim 19 including configuring the video data processor to translate alert data to one of a plurality of formats compatible with one of a plurality of different alarm monitoring systems.
